(19) United States
(12) Patent Application Publication
(10) Pub. No.: US 2025/0335084 A1
(43) Pub. Date: Oct. 30, 2025

(54) TOUCH SCREEN OPERATION MODES

(71) Applicant: DELL PRODUCTS L.P., Round Rock, TX (US)

(72) Inventor: Kai Wang, Shanghai (CN)

(21) Appl. No.: 18/792,248

(22) Filed: Aug. 1, 2024

(30) Foreign Application Priority Data
Apr. 28, 2024 (CN) 202410524092.7

(51) Int. Cl. G06F 3/0488; G06F 3/0354; G06F 3/04817

(52) U.S. Cl. CPC G06F 3/0488; G06F 3/03545; G06F 3/04817

(57) ABSTRACT

An information handling system includes a touchscreen display, a touchscreen sensor, and a processor. The touchscreen sensor detects first and second inputs. The processor receives a user input to select an input mode for the touchscreen sensor. When the selected input mode is a continuous workflow mode, the processor determines a first input type of the first input and a second input type of the second input. The processor determines a first amount of time between the first and second inputs. In response to the first amount of time being less than a predetermined threshold and based on the first input type, the processor sets a first position of the first input as a start point. In response to the first amount of time being less than a predetermined threshold and based on the second input type, a second position of the second input as an end point. When a first application is being executed, the processor connects the start and end points on the touchscreen display.

### FIELD OF THE DISCLOSURE

The present disclosure generally relates to information handling systems, and more particularly relates to setting a touch screen operation mode based on input types and number of inputs.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a touchscreen sensor that may detect first and second inputs. The system may receive a user input to select an input mode for the touchscreen sensor. When the selected input mode is a continuous workflow mode, the system may determine a first type of the first input and a second type of the second input. The system may determine a first amount of time between the first and second inputs. If the first amount of time is less than a predetermined threshold and based on the first input type, the system may set a first position of the first input as a start point. If the first amount of time is less than a predetermined threshold and based on the second input type, the system may set a second position of the second input as an end point. When a first application is being executed, the system may connect the start and end points on a display.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of an information handling according to at least one embodiment of the present disclosure;

FIG. 2 is a flow diagram of a method for determining a length of time between multiple inputs and a workflow mode according to at least one embodiment of the present disclosure;

FIG. 3 is a flow diagram of a method for connecting input positions during a continuous workflow mode according to at least one embodiment of the present disclosure;

FIG. 4 is a flow diagram of a method for performing operations based on multiple inputs when a particular application is being executed according to at least one embodiment of the present disclosure;

FIG. 5 is a flow diagram of a method for performing operations based on multiple inputs in a two user mode according to at least one embodiment of the present disclosure; and

FIG. 6 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

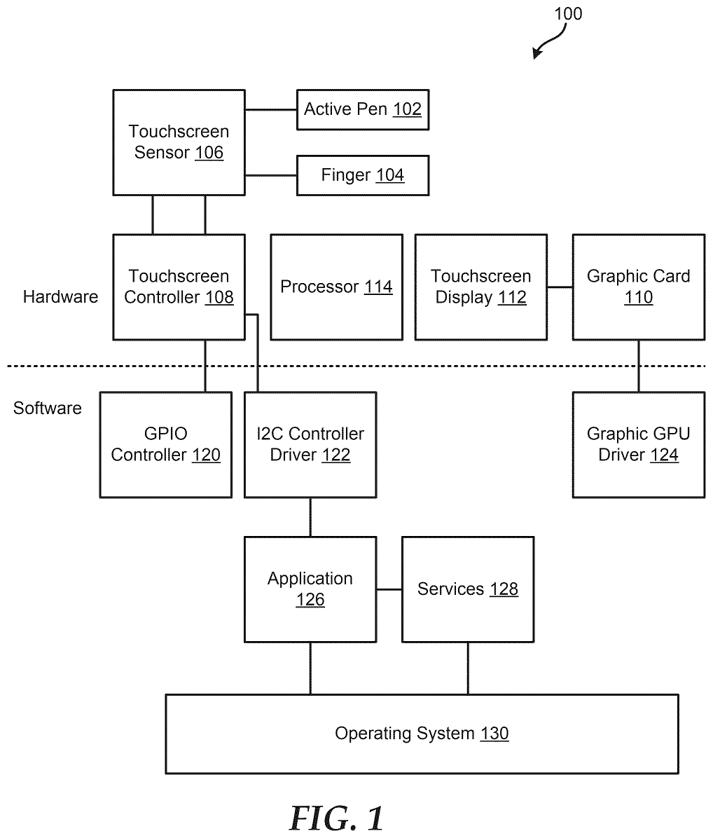

FIG. 1 illustrates an information handling system 100, an active pen 102, and a finger 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a touchscreen sensor 106, a touchscreen controller 108, and a graphic card 110, a touchscreen 112, a processor 114, a graphic processor input/output (GPIO) controller 120, an inter-integrated circuit (I2C) controller driver 122, a graphic processing unit (GPU) driver 124, one or more applications 126, one or more services 128, and an operating system (OS) 130. In an example, touchscreen controller 108 and processor may be separate hardware processing components, may be incorporated into a single hardware component, or the like. Thus, touchscreen controller 108 and processor 114 may be any suitable processors able to perform any suitable operations described herein. Information handling system 100 includes may include additional hardware and software components without varying from the scope of this disclosure.

In an example, a user may not connect a mouse or keyboard to touchscreen 112 of information handling system 100. Instead, the user may utilize a pen or finger as a main input to the information handling system. Touchscreen 112 may be any suitable touchscreen such as a notebook touchscreen display, AIO display, or the like. Previous information handling systems, a user may not be able to draw an absolutely straight line using the pen or finger without using a selected “line” tool. In situations involving a large touchscreen display, an amount of time to draw the line and the difficultly to make the line straight increases as the size of the touchscreen display increases. In previous information handling systems, a default OS behavior is to detect all inputs, such as finger, pen, and mouse inputs, as the same function and one selector or cursor. In this situation, a processor executing the OS may not be able to distinguish between two users even if the users are utilizing different input devices, such as a finger and a pen.

Information handling system 100 may be improved by touchscreen controller or processor 108 executing OS 130 being able to detect input types, the number of inputs, and the position of the input. In an example, touchscreen processor 108 may receive this information from touchscreen sensor 106. Processor 114 may execute one or more services 128 to determine a workflow mode for touchscreen information handling system 100. In certain examples, the different workflow modes may include, but are not limited to, one user with multiple inputs having the same function, one user with multiple inputs having different functions, and two users with multiple inputs having different functions.

During operation of information handling system 100, processor 114 may execute application 126 and service 128 to enable touchscreen display 112. When touchscreen display 112 is enabled touchscreen sensor 106 and touchscreen controller 108 may detect input types, the number of inputs, and the positions of the inputs on touchscreen display 112. In an example, GPIO controller 120 and I2C controller driver may receive data from touchscreen controller 108 and provide the received data to application 126, services 128, and OS 130. In certain examples, graphic GPU driver 124 may receive data from application 126, services 128, and OS 130. GPU driver 124 may utilize this data to provide control information to graphic card 110 which in turn may control touchscreen display 112 to provide the desired outputs based on the received input from the user.

In an example, a graphical user interface (GUI) may be provided on touchscreen display 112 and a user may select different soft buttons on the GUI to switch information handling system 100 among the possible modes. In certain examples, information handling system 100 may also include hardware buttons to switch information handling system 100 among the possible modes. In an example, all of the possible modes may enable touchscreen display 112 to interface with touch input applications, such as application 126.

In certain examples, if an individual selects a legacy or one user one input operation mode, processor 114, via application 126 or service 128, may treat active pen 102 and finger 104 as separate inputs for the same function. For example, if an individual uses finger 104 to draw a line on touchscreen display 112, removes the finger, and begins using pen 102, touchscreen sensor 106 and touchscreen controller 108 may provide the different input types to processor 114. While in the legacy or one user one input operation, processor 114 may treat pen 102 and finger 104 as the same input. In this situation drawing, selecting, or otherwise modifying images on touchscreen display 112 may be the same whether the individual is using pen 102 or finger 104.

In an example, if an individual selects a continuous workflow or one user two inputs operation mode, processor 114, via application 126 or service 128, may treat active pen 102 and finger 104 as a continuous workflow as long as the inputs are detected within a particular amount of time. For example, if the user wants to draw a straight line on touchscreen display 122, the user may utilize both pen 102 and finger 104 to draw a substantially straight line. The user may utilize pen 102 and 104 to select one or more lines of a word document, select one or more images on touchscreen display 112, or the like.

In an example, the individual may place pen 102 in physical communication with touchscreen display 112, and touchscreen sensor 106 may detect the input type, timestamp, and location of the input on the touchscreen display. Touchscreen controller 108 or processor 114 may set the positional coordinates, such (X1, Y1), of pen 102 as a start point for an action. Then, individual may place finger 104 at another place on touchscreen display 112. Touchscreen sensor 106 may detect the input type, timestamp, and location of the input on touchscreen display 112. In an example, processor may utilize the timestamps associated with pen 102 and finger 104 to determine whether the two inputs occurred within a particular amount of time. In certain examples, particular amount of time between the inputs may be compared to a threshold, such as one second.

If the amount of time between the timestamp for pen 102 and the timestamp for finger 104 is less than the threshold, touchscreen controller 108 or processor 114 may set the positional coordinates, such (X2, Y2), of finger 104 as an end point for the action. In an example, processor 114 may coordinate the start point and end point for any action performed by application 126 on touchscreen display 112. For example, processor 114 may cause GPU driver 124 and graphic card 110 to one an absolutely straight line between the point of pen 102, such as (X1, Y1), and the point of finger 104, such as (X2, Y2), on touchscreen display 112.

In certain examples, if touchscreen sensor 106 detects more than two inputs and determines that the amount of time between two sequential inputs is less than the threshold, processor 114 may automatically cause graphics card 110 to connect all input points. For example, touchscreen sensor 106 may determine a location (X1, Y1) for a first finger 104, a location (X2, Y2) for pen 102, and a location (X3, Y3) for a second finger. In this example, if the amount of time between first finger 104 and pen 102 is less than the threshold, and the amount of time between the pen and the second finger is also less than the threshold, processor 114 may automatically cause graphics card 110 to connect points (X1, Y1), (X2, Y2), and (X3, Y3).

In certain examples, the individual or user may configure particular functions to be performed based on the last input type in a sequence of inputs. For example, if three or more inputs are received and the last input type is pen 102, processor 114 may automatically cause graphics card 110 to connect points all of the points and create a closed shape. In this example, if the input points are (X1, Y1), (X2, Y2), and (X3, Y3), processor 114 may cause graphics card 110 to create a closed triangle with the input points on touchscreen display 112. However, if the last input type is not pen 102, such that it is finger 104, processor 114 may cause graphics card 110 to connect all of the input points on touchscreen display 112 without closing the shape. Instead, lines may be drawn from point to point on touchscreen display 112 and the lines may connect the points in the order that the inputs were received on the touchscreen display.

In an example, application 126 may be any suitable GUI application, such as a web application, a word processing application, a number spreadsheet application, a presentation slide application, a GUI folder application, or the like. In this situation, touchscreen sensor 106 may detect an input, such as pen 102 or finger 104, and provide the location (X1, Y1) of the input as the start point for an operation. Touchscreen sensor 106 may detect another input, such as finger 104 or pen 102, and provide the location (X2, Y2) of this input as the end point for the operation.

Based on the start point location and the end point location, processor 114 may perform any suitable operation associated with images on touchscreen display 112 from application 126. For example, processor 114 may select one or more lines of text that extend from the start point to the end point. Processor 114 may also select one or more cells of a spreadsheet that extend from the start point to the end point. Processor 114 may further select one or more slides in a presentation that extend from the start point to the end point or select one or more documents/folders in a GUI file that extend from the start point to the end point.

In an example, if an individual selects two user and two inputs operation mode, processor 114, via application 126 or service 128, may treat active pen 102 and finger 104 as different user inputs. In certain examples, touchscreen sensor 106 may distinguish between inputs from pen 102 and inputs from finger 104. In these situations, actions performed based on pen 102 may be separate from actions performed based on finger 104.

If application 126 is a drawing application and one user is drawing with pen 102 and another user is drawing with finger 104, processor 114 may treat the inputs as two different drawing profile. In an example, touchscreen sensor 106 may provide location information and input type identification for both pen 102 and finger 104 to processor 114. In this example, processor 114 may cause graphic card 110 to provide different drawings on touchscreen display 112. For example, drawings associated with pen 102 may be a particular color, pattern, thickness, or the like, and drawings associated with finger 104 may be a different color, different pattern, different thickness, or the like.

In an example, application 126 may be a gaming application and two users may be able to interact with the game using the different inputs. In this example, pen 102 may be assigned to one user and finger 104 may be assigned to another user. Touchscreen sensor 106 provide location information and input type identification for both pen 102 and finger 104 to processor 114. Based on the data from touchscreen sensor 106, processor 114 may perform different actions at different locations based on pen 102 and finger 104. For example, if touchscreen sensor 106 detects pen 102 at one location (X1, Y1), processor 114 may perform an action or task associated with a first user at this location. If touchscreen sensor 106 detects finger 104 at another location (X2, Y2), processor 114 may perform an action associated with a second user at this location.

As described herein, different operations may be performed on touchscreen display 112 based on the operation mode and the input type, such as pen 102 or finger 104. Touchscreen sensor 106 and touchscreen controller 108 may provide processor 114 with the data to distinguish between the input types, the locations, and an amount of time between two sequential inputs. Processor 114, via application 126 and service 128, may utilize this data to cause graphic card 110 to provide different outputs on touchscreen display 112 as described herein.

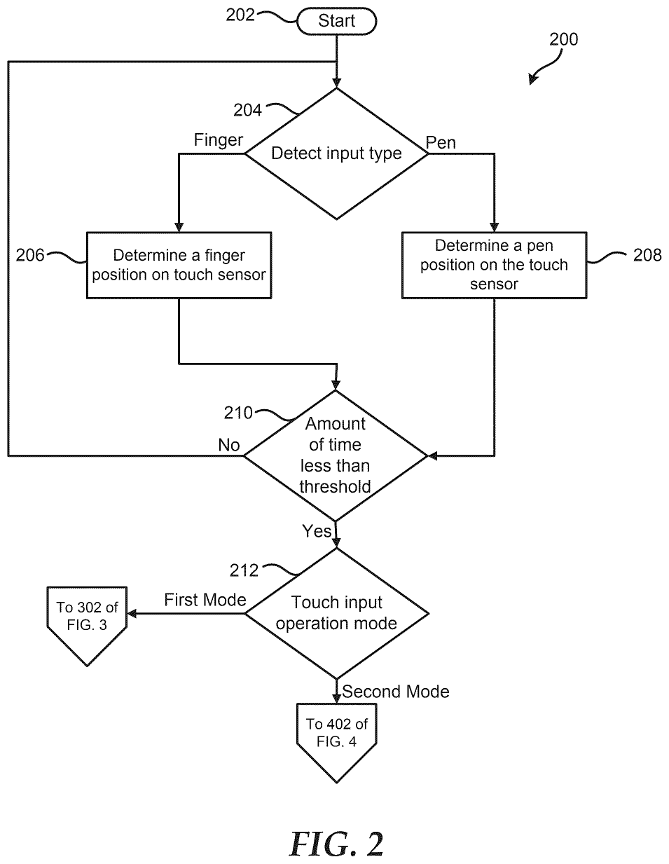

FIG. 2 is a flow diagram of a method 200 for determining a length of time between multiple inputs and a workflow mode according to at least one embodiment of the present disclosure, starting at step 202. It will be readily appreciated that not every method step set forth in this flow diagram is always necessary, and that certain steps of the methods may be combined, performed simultaneously, in a different order, or perhaps omitted, without varying from the scope of the disclosure. FIG. 2 may be employed in whole, or in part, touchscreen 106, touchscreen controller 108, graphic card 110, and processor 114 of information handling system 100 in FIG. 1, or any other type of controller, device, module, processor, or any combination thereof, operable to employ all, or portions of, the method of FIG. 2.

At step 204, a type of input is detected. In certain examples, the input type may be a pen, a finger, a mouse, or any other suitable component to interface with a touchscreen display of an information handling system. If the input type is a finger, a finger position is determined at block 206. In an example, the finger position may be determined by a touchscreen sensor. If the input type is a pen, a pen position is determined at block 208. In an example, the pen position may be determined by the touchscreen sensor.

At block 210, a determination is made whether an amount of time between two inputs is less than a threshold. In an example, the threshold may be any suitable length of time, such as 1 second, 2 seconds, or the like. If the detected input is a first input, then the amount of time is determined to be greater than the threshold when the threshold is exceeded. In an example, the amount of time between two inputs may be determined based on a difference between a timestamp of the first input and a timestamp of the second input.

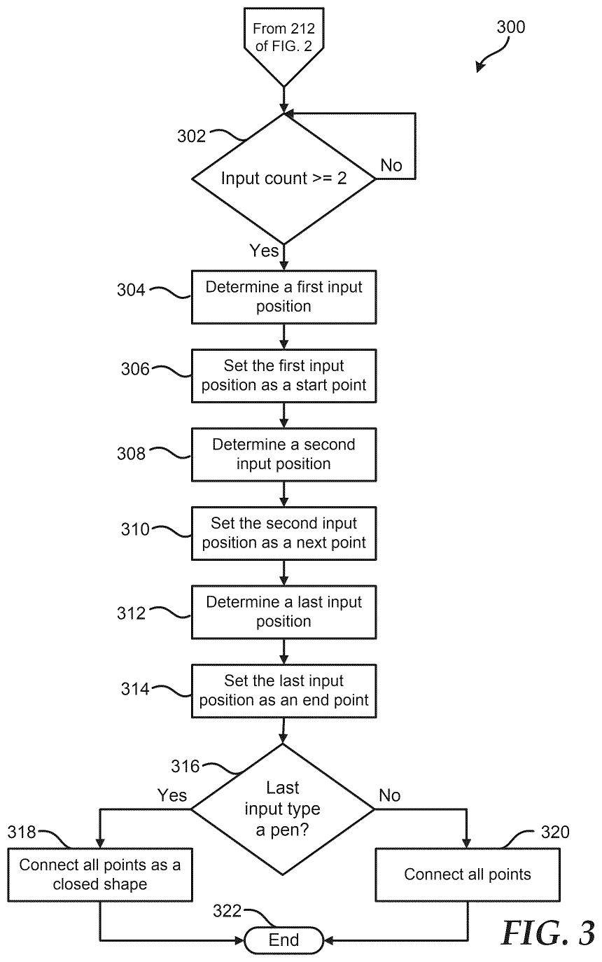

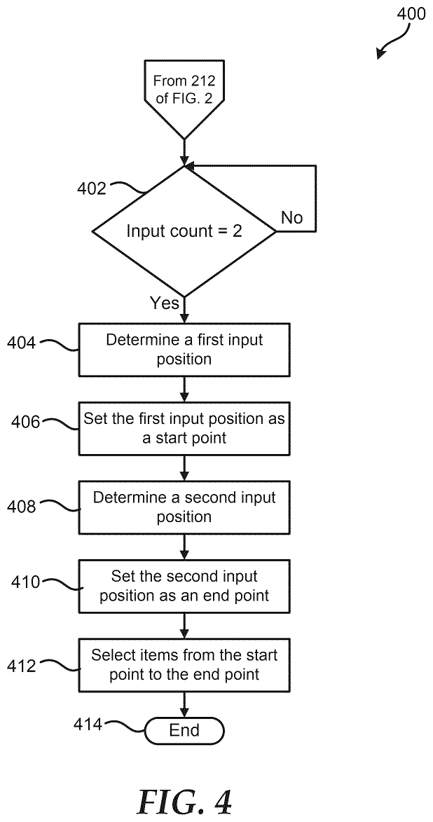

If the amount of time is greater than the threshold, the flow continues as stated above at block 204. If the amount of time is less than the threshold, a touch input operation mode is determined at block 212. If the operation mode is a first mode, the flow continues at block 302 of FIG. 3. If the operation mode is a second mode, the flow continues at block 402 of FIG. 4. In certain examples, the different operation modes may be any suitable user selectable modes including, but not limited to, a continuous workflow or one user two inputs operation mode within a drawing application, a continuous workflow or one user two inputs operation mode within productivity application, or the like.

FIG. 3 is a flow diagram of a method 300 for connecting input positions during a continuous workflow mode according to at least one embodiment of the present disclosure, starting at block 302. It will be readily appreciated that not every method step set forth in this flow diagram is always necessary, and that certain steps of the methods may be combined, performed simultaneously, in a different order, or perhaps omitted, without varying from the scope of the disclosure. FIG. 3 may be employed in whole, or in part, touchscreen 106, touchscreen controller 108, graphic card 110, and processor 114 of information handling system 100 in FIG. 1, or any other type of controller, device, module, processor, or any combination thereof, operable to employ all, or portions of, the method of FIG. 3.

At block 302, a determination is made whether the number of detected inputs is two or more. In an example, the inputs may be different types of inputs on a touchscreen of an information handling system. When the number of detected inputs is two or more, a first input position is determined at block 304. In an example, the first input position may be a location on the touchscreen display where a first input is detected by the touchscreen sensor. The input may be a finger or an active pen. At block 306, the first input position is set as a start point. In certain examples, the start point may be associated with a particular action, such as drawing a line on the touchscreen display.

At block 308, a second input position is determined. In an example, the second input position may be a location on the touchscreen display where a second input is detected by the touchscreen sensor. At block 310, the second input position is set as a next point. In certain examples, the next point may be associated with the particular action. At block 312, a third input position is determined. In an example, the third input position may be a location on the touchscreen display where a third input is detected by the touchscreen sensor. At block 314, the third input position is set as a last point. In certain examples, the last point may be associated with the particular action. In certain examples, any suitable number of inputs may be detected and assigned as a point for the particular action.

At block 316, a determination is made whether the last input type is a pen. If the last input type is a pen, all points are connected as a closed shape at block 318 and the flow ends at block 320. In an example, if there are three inputs, the points are connected as a closed triangle. If the last input type is not a pen, all points are connected without making a closed shape at block 322 and the flow ends at block 320. In an example, the points are connected sequentially in the order the points were detected.

FIG. 4 is a flow diagram of a method 400 for performing operations based on multiple inputs when a particular application is being executed according to at least one embodiment of the present disclosure, starting at block 402. It will be readily appreciated that not every method step set forth in this flow diagram is always necessary, and that certain steps of the methods may be combined, performed simultaneously, in a different order, or perhaps omitted, without varying from the scope of the disclosure. FIG. 4 may be employed in whole, or in part, touchscreen 106, touchscreen controller 108, graphic card 110, and processor 114 of information handling system 100 in FIG. 1, or any other type of controller, device, module, processor, or any combination thereof, operable to employ all, or portions of, the method of FIG. 4.

At block 402, a determination is made whether two inputs have been detected. In an example, the inputs may be detected by a touchscreen sensor for a touchscreen display in an information handling system. In response to two inputs being detected, a first input position is determined at block 404. In an example, the first input position may be a location on the touchscreen display where a first input is detected by the touchscreen sensor. The input may be a finger or an active pen. At block 406, the first input position is set as a start point. In certain examples, the start point may be associated with a particular action, such as selecting images on the touchscreen display.

At block 408, a second input position is determined. In an example, the second input position may be a location on the touchscreen display where a second input is detected by the touchscreen sensor. At block 410, the second input position is set as an end point for the particular action. At block 412, items or images on the touchscreen display are selected extending from the start point to the end point, and the flow ends at block 414. In an example, the items or images may be one or more lines in a word processing application, one or more cells of a spreadsheet application, one or more slides in a presentation application, one or more objects in a GUI file system, or the like.

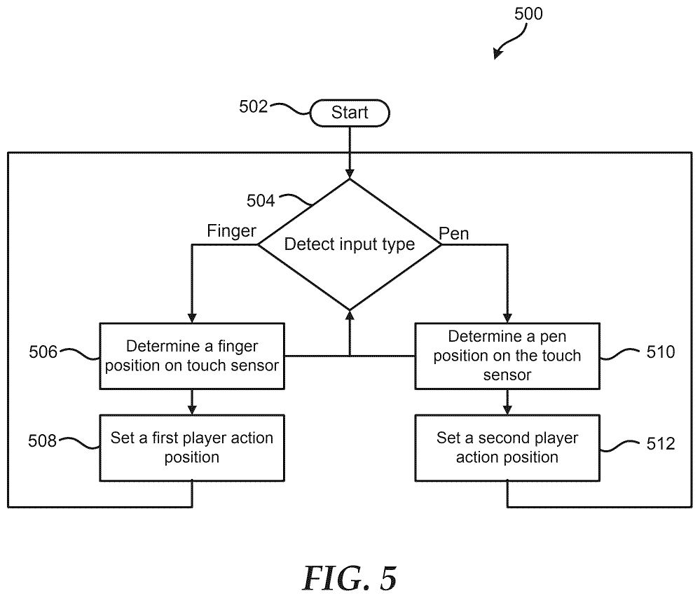

FIG. 5 is a flow diagram of a method 500 for performing operations based on multiple inputs in a two user mode according to at least one embodiment of the present disclosure, starting at block 502. It will be readily appreciated that not every method step set forth in this flow diagram is always necessary, and that certain steps of the methods may be combined, performed simultaneously, in a different order, or perhaps omitted, without varying from the scope of the disclosure. FIG. 5 may be employed in whole, or in part, touchscreen 106, touchscreen controller 108, graphic card 110, and processor 114 of information handling system 100 in FIG. 1, or any other type of controller, device, module, processor, or any combination thereof, operable to employ all, or portions of, the method of FIG. 5.

At block 504, an input type is detected. If the input type is a finger, a finger position is determined by the touchscreen sensor at block 506. At block 508, a first player action is set at the position of the finger, and the flow continues as stated above at block 504. If the input type is a pen, a pen position is determined by the touchscreen sensor at block 510. At block 512, a first player action is set at the position of the pen, and the flow continues as stated above at block 504. In an example, the different actions for the different players or individuals may be drawing lines, performing gaming operations, or the like.

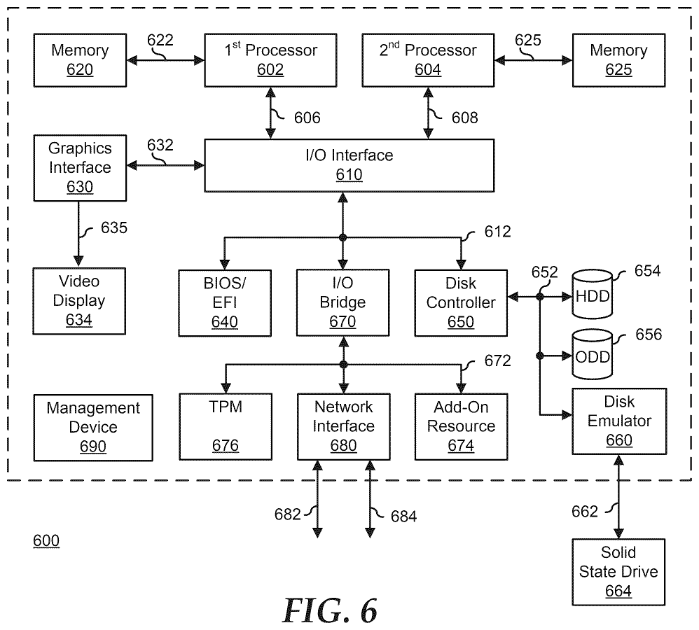

FIG. 6 shows a generalized embodiment of an information handling system 600 according to an embodiment of the present disclosure. Information handling system 600 may be substantially similar to information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operates to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656, a disk emulator 660 connected to an external solid state drive (SSD) 662, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 662, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 4394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off of a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a touchscreen display;
a touchscreen sensor to detect first and second inputs; and
a processor to communicate with the touchscreen sensor, the processor to:
receive a user input to select an input mode for the touchscreen sensor; and
when the selected input mode is a continuous workflow mode, the processor to:
determine a first input type of the first input;
determine a second input type of the second input;
determine a first amount of time between the first and second inputs; and
in response to the first amount of time being less than a predetermined threshold:
based on the first input type, set a first position of the first input as a start point;
based on the second input type, set a second position of the second input as an end point; and
when a first application is being executed, connect the start and end points on the touchscreen display.

2. The information handling system of claim 1, wherein the processor further to:
determine whether the second input type is a pen; and
based on the second input type being a pen, connect the start and end points with a straight line on the touchscreen display.

3. The information handling system of claim 1, wherein when a word processing application is being executed, the processor to select one or more lines of text extending from the start point to the end point on the touchscreen display.

4. The information handling system of claim 3, wherein when a graphical user interface is being executed, the processor further to: select one or more graphical user interface icons extending from the start point to the end point on the touchscreen display.

5. The information handling system of claim 1, wherein the processor further to:
determine a third input type of a third input;
determine a second amount of time among the first, second, and third inputs; and
in response to the second amount of time being less than the predetermined threshold:
set a third position of the third input as a next point;
determine whether the second input type is a pen;
based on the second input type being a pen, connect the start and end points with a straight line on the touchscreen display; and
when the first application is being executed, connect the start and end points on the touchscreen display.

6. The information handling system of claim 1, wherein when the selected input mode is a two user operation mode, the processor to:
set a first user action at the first position; and
set a second user action at the second position.

7. The information handling system of claim 6, wherein the first action is a first line drawn in a first color on the touchscreen display and the second action is a second line drawn in a second color on the touchscreen display.

8. A method comprising:
receiving, by a processor of an information handling system, a user input to select an input mode for a touchscreen sensor of the information handling system; and
when the selected input mode is a continuous workflow mode:
determining a first input type of the first input;
determining a second input type of the second input;
determining a first amount of time between the first and second inputs; and
in response to the first amount of time being less than a predetermined threshold:
based on the first input type, setting a first position of the first input as a start point;
based on the second input type, setting a second position of the second input as an end point; and
when a first application is being executed, connecting, by the processor, the start and end points on a touchscreen display.

9. The method of claim 8, further comprising:
determining whether the second input type is a pen; and
based on the second input type being a pen, connecting the start and end points with a straight line on the touchscreen display.

10. The method of claim 8, wherein when a word processing application is being executed, the method further comprises: selecting one or more lines of text extending from the start point to the end point on the touchscreen display.

11. The method of claim 10, wherein when a graphical user interface is being executed, the method further comprises: selecting one or more graphical user interface icons extending from the start point to the end point on the touchscreen display.

12. The method of claim 8, further comprising:
determining a third input type of a third input;
determining a second amount of time among the first, second, and third inputs; and
in response to the second amount of time being less than the predetermined threshold:
setting a third position of the third input as a next point;
determining whether the second input type is a pen;
based on the second input type being a pen, connecting the start and end points with a straight line on the touchscreen display; and
when the first application is being executed, connecting the start and end points on the touchscreen display.

13. The method of claim 8, wherein when the selected input mode is a two user operation mode, the method further comprises:
setting a first user action at the first position; and
setting a second user action at the second position.

14. The method of claim 13, wherein the first action is a first line drawn in a first color on the touchscreen display and the second action is a second line drawn in a second color on the touchscreen display.

15. A non-transitory computer-readable medium including code that when executed causes a processor to perform a method, the method comprising:
receiving a user input to select an input mode for a touchscreen sensor; and
when the selected input mode is a continuous workflow mode:
determining a first type of the first input;
determining a second type of the second input;
determining a first amount of time between the first and second inputs; and
in response to the first amount of time being less than a predetermined threshold:
based on the first input type, setting a first position of the first input as a start point;
based on the second input type, setting a second position of the second input as an end point; and
when a first application is being executed, connecting the start and end points on a touchscreen display.

16. The non-transitory computer-readable medium of claim 15, wherein the method further comprises:
determining whether the second input type is a pen; and
based on the second input type being a pen, connecting the start and end points with a straight line on the touchscreen display.

17. The non-transitory computer-readable medium of claim 15, wherein when a word processing application is being executed, the method further comprises: selecting one or more lines of text extending from the start point to the end point on the touchscreen display.

18. The non-transitory computer-readable medium of claim 15, wherein when a graphical user interface is being executed, the method further comprises: selecting one or more graphical user interface icons extending from the start point to the end point on the touchscreen display.

19. The non-transitory computer-readable medium of claim 15, the method further comprising:
determining a third input type of a third input;
determining a second amount of time among the first, second, and third inputs; and
in response to the second amount of time being less than the predetermined threshold:
setting a third position of the third input as a next point;
determining whether the second input type is a pen;
based on the second input type being a pen, connecting the start and end points with a straight line on the touchscreen display; and
when the first application is being executed, connecting the start and end points on the touchscreen display.

20. The non-transitory computer-readable medium of claim 15, wherein when the selected input mode is a two user operation mode, the method further comprises:
determining whether the second input type is a pen; and
based on the second input type being a pen, connecting the start and end points with a straight line on the touchscreen display.
